(19) United States
(12) Patent Application Publication
(10) Pub. No.: US 2025/0245734 A1
(43) Pub. Date: Jul. 31, 2025

(54) PRE-ORDER CUSTOMER BIDDING

(71) Applicant: Walmart Apollo, LLC, Bentonville, AR (US)

(72) Inventors: Sian Chen, Lewisville, TX (US); Abdullah Ahmed, Mansfield, TX (US); Lakshmi Priyanka Parimi, Frisco, TX (US)

(21) Appl. No.: 18/429,184

(22) Filed: Jan. 31, 2024

(51) Int. Cl. G06Q 30/08

(52) U.S. Cl. CPC G06Q 30/08

(57) ABSTRACT

Pre-order bidding systems may impede, avoid, and/or disqualify bids submitted by bot buyers. Pre-order bidding systems may prioritize bids submitted by registered buyers based at least partially on user scores. A user score may be at least partially based on a purchase history of the registered buyer, how often the registered buyer has confirmed/withdrawn successful bids following seller finalization, how many bids/purchases the registered buyer has submitted/made in the online marketplace, and/or an age of the registered buyer's account. Pre-order bidding systems may allow registered buyers to submit a downpayment to improve the likelihood that their bid will be successful or otherwise prioritized over bids from other registered buyers. Pre-order bidding systems may utilize blind bids, as well as hide bidding requirements and/or restrictions.

### BACKGROUND

A common problem for online retailers and buyers alike is that items being sold in limited volumes are often bought-out on release by automated bots and similar classes of buyers, who then re-sell them elsewhere (e.g., Ebay, etc.) at a significant markup. This problem has become increasingly difficult to address, as bots have evolved to avoid traditional countermeasures. New and innovative solutions for deterring bot purchases are therefore needed.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

In one example, a method for facilitating pre-orders is provided. The method includes receiving, from a seller, a request to list a product for pre-order in an online marketplace managed by a retailer, creating, by the retailer, a pre-order listing for the product in the online marketplace in response to receiving the request from the seller, receiving, via the pre-order listing, a bid from a first registered buyer and a bid from a second registered buyer, and sending, to the seller, a prioritized list of bids for the pre-order listing. In this example, the bid from the second registered buyer offers a higher bidding price than the bid from the first registered buyer, and the bid from the first registered buyer is prioritized over the bid from the second registered buyer at least partially based on a user score assigned to the first registered buyer being higher than a user score assigned to the second registered buyer.

In another example, a system for facilitating pre-orders is provided. The system includes a processor and memory storing computer program code for execution by the processor. The computer program code is configured, upon execution by the processor, to cause the processor to receive, from a seller, a request to list a product for pre-order in an online marketplace managed by a retailer, to create, by the retailer, a pre-order listing for the product in the online marketplace in response to receiving the request from the seller, to receive, via the pre-order listing, a bid from a first registered buyer and a bid from a second registered buyer, and to send, to the seller, a prioritized list of bids for the pre-order listing. In this example, the bid from the second registered buyer offers a higher bidding price than the bid from the first registered buyer, and the bid from the first registered buyer is prioritized over the bid from the second registered buyer at least partially based on a user score assigned to the first registered buyer being higher than a user score assigned to the second registered buyer.

In yet one example, a computer storage medium storing computer-executable instructions is provided. In this example, the computer-executable instructions includes instructions to receive, from a seller, a request to list a product for pre-order in an online marketplace managed by a retailer, to create, by the retailer, a pre-order listing for the product in the online marketplace in response to receiving the request from the seller, to receive, via the pre-order listing, a bid from a first registered buyer and a bid from a second registered buyer, and to send, to the seller, a prioritized list of bids for the pre-order listing. In this example, the bid from the second registered buyer offers a higher bidding price than the bid from the first registered buyer, and the bid from the first registered buyer is prioritized over the bid from the second registered buyer at least partially based on a user score assigned to the first registered buyer being higher than a user score assigned to the second registered buyer.

### BRIEF DESCRIPTION OF THE DRAWINGS

To present description will be better understood from the following detailed description read in light of the accompanying drawings, wherein:

FIG. 1 is an exemplary block diagram illustrating a network for providing an online marketplace;

FIG. 2 is an exemplary system diagram illustrating a system for listing products available for pre-order in an online marketplace;

FIG. 3 is an exemplary protocol diagram illustrating a protocol for operating a pre-order system;

FIG. 4 is an exemplary flowchart illustrating a method for operating a pre-order system; and

FIG. 5 is an exemplary block diagram illustrating a computing apparatus for operating the pre-order systems disclosed herein.

### DETAILED DESCRIPTION

Modern online marketplaces are heavily impacted by automated bots as a single prolific reseller can deploy dozens or even hundreds of bots. Bots are significantly more efficient at identifying purchase opportunities, and executing bids/purchases, than traditional retail customers, and as a result, limited release products are often bought out before the target customer base even realizes the purchase opportunity exists. Bot purchases are generally undesirable from the perspective of retailers, sellers, and buyers. In particular, a retailer/seller may wish to increase their traditional retail customer base, gauge the demand for a new product among the traditional retail customer base, and/or reward loyal retail customers with the opportunity to purchase limited release products (e.g., recently released gaming consols, etc.) that are not widely available elsewhere. Likewise, traditional retail customers may want to shop in online marketplaces without having to compete with bots.

Disclosed herein are example pre-order bidding systems designed to impede, avoid, and/or disqualify bids submitted by bot buyers. Example pre-order bidding systems may prioritize bids submitted by registered buyers based at least partially on user scores assigned to the registered buyer. As a result, registered buyer(s) offering lower bidding price(s) may be prioritized over registered buyer(s) offering higher bidding price(s) based on the user scores assigned to the registered buyers. In one example, a user score assigned to a registered buyer may be at least partially based on a purchase history of the registered buyer. The purchase history of a registered buyer may include various purchase history information pertaining to previous purchases and/or purchase attempts made by the registered buyer stored in a user database. For instance, purchase history information may include statistical information relating to how many times the registered buyer has purchased a given product or products in a given product class/category. Purchase history information may also include suspicious bidding activity and/or suspicious purchases associated with the registered buyer. It should be appreciated that the purchase history of a given registered buyer may include purchases/bids made by other accounts (e.g., accounts of other registered buyers) sharing certain commonalities with the registered buyer, such as purchases/bids made from accounts sharing the same IP address, the same shipping address, or the same payment information (credit card, bank account, etc.) as the registered buyer. In another example, a user score assigned to a registered buyer may be at least partially based on how often the registered buyer has confirmed/withdrawn successful bids following seller finalization of previous pre-order listings on the online marketplace. For instance, registered buyers that are more likely to confirm successful bids following seller finalization may be assigned higher user scores. Conversely, the registered buyers that have shown a propensity to withdraw successful bids following seller finalization may be assigned lower user scores. In yet another example, a user score assigned to a registered buyer is at least partially based how many bids/purchases the registered buyer has submitted/made in the online marketplace and/or an age of the registered buyer's account. For instance, long-held accountholders and/or accountholders that have been active purchasers/bidders may be assigned a higher user score than new accountholders and/or accountholders that have been relatively inactive.

Example pre-order bidding systems may allow registered buyers to submit a downpayment with their bids to improve the likelihood that their bid will be successful or otherwise prioritized over bids from other registered buyers. For instance, the presence or absence of a downpayment may be taken into account when assigning the user score. Example pre-order bidding systems may also utilize blind bids such that a bidding price offered by a given registered buyer is hidden from the other registered buyers. Example pre-order bidding systems may also hide bidding requirements and/or restrictions from registered buyers in an attempt to disqualify and/or identify bot buyers. For instance, a pre-order listing may set a minimum bidding price, a maximum bidding price, and/or a maximum number of bids permitted to be made from the same registered buyer. One or more of these requirements and/or restrictions may be hidden from registered buyers. In some situations, bids failing to satisfy a hidden requirement or otherwise violating a hidden restriction may result in disqualification of the bid and/or registered buyer. In one example, bids in excess of a maximum bidding price will be accepted, but the difference between the offered bidding price and the maximum bidding price is refunded to the customer (or otherwise discounted during payment processing). The above-mentioned examples, as well as additional features and aspects, are described in greater detail below.

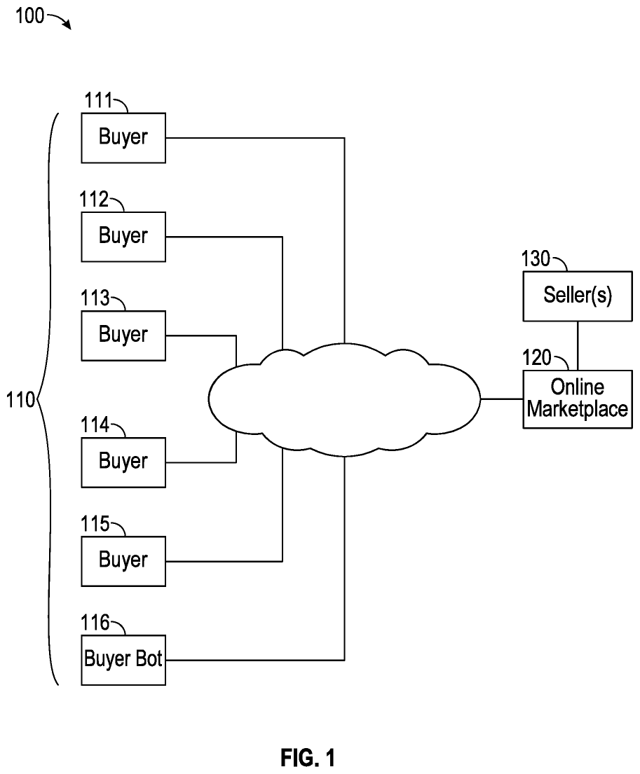

FIG. 1 is an exemplary block diagram illustrating a network 100 for providing an online marketplace 120. The online marketplace 120 may be managed by a retailer for the purpose of listing products offered by seller(s) 130 for purchase and/or pre-order by a pool of registered buyers 110. The pool of registered buyers 110 may include both traditional retail buyers 111-115 and bot buyer(s) 116. Traditional retail buyers 111-115 may generally be end-users or customers who are otherwise purchasing/pre-ordering products without an intent to re-sell them for a product, e.g., households, businesses buying products for their employees or for business use, etc. In contrast, bot buyer(s) 116 and other similar types of buyers (e.g., scalpers, etc.) may generally purchase or pre-order limited release items for the purpose of re-selling them for a profit. The seller(s) 130 may include both in-house sales staff of the retailer as well as third party sellers that access the online marketplace 120 as a service-based platform. The online marketplace 120 may be managed by a retailer that also manages brick and mortar retail locations. It should be appreciated that some products listed for purchase or pre-order via the online marketplace 120 may also be available at the retailer's brick and mortar retail locations, while other products may be exclusively offered (through the retailer) via the online marketplace 120 and therefore not available at the retailer's brick and mortar retail locations.

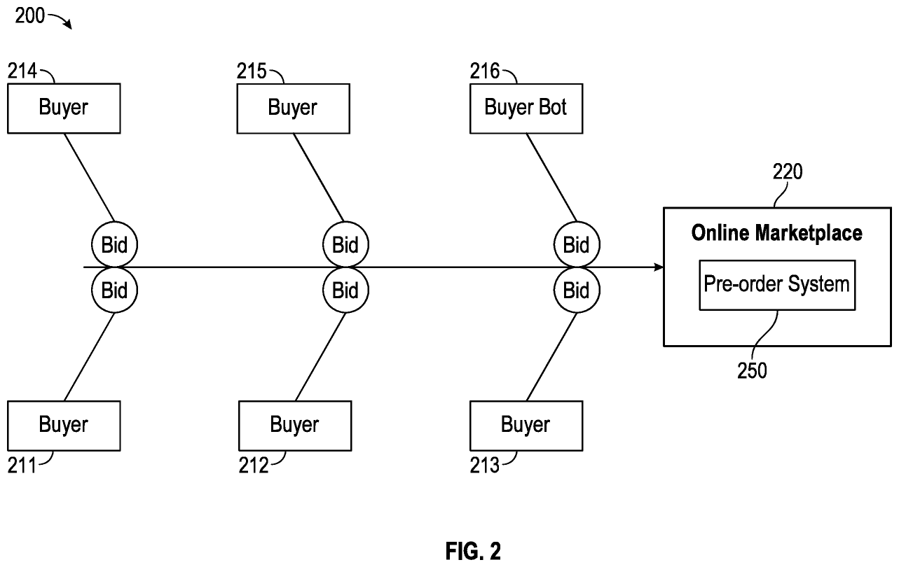

As mentioned above, some products (e.g., new products, products offered in limited quantities, etc.) may be listed for pre-order via an online marketplace. FIG. 2 is an exemplary system diagram illustrating a system 200 for listing products available for pre-order in an online marketplace 220. As shown, the online marketplace 220 includes a pre-order system 228 that allows registered buyers 211-216 to submit bids. In some examples, the bids submitted by the registered buyers 211-216 are “blind bids” meaning that the bidding price offered by a bid submitted by one registered buyer (e.g., registered buyer 211) is hidden from the other registered buyers (e.g., registered buyers 212-216). In general, blind bids may inhibit bidding strategies commonly used by bot buyers. For instance, bot buyers may generally bid a small amount (e.g., one dollar) more than the highest bidding price. As such, blind bids may make it more difficult for bots to determine what bidding price is required to secure a successful bid in a given listing.

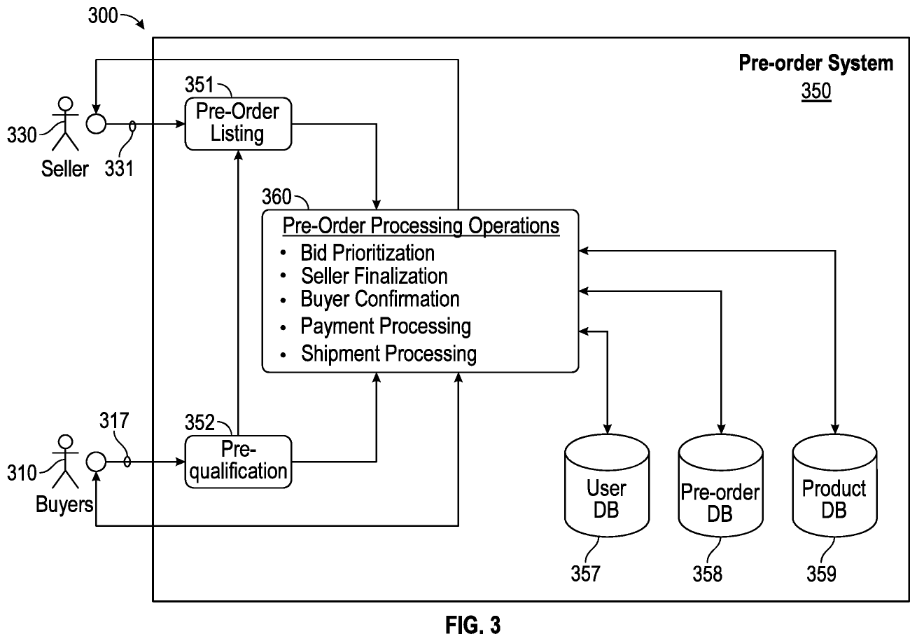

FIG. 3 is an exemplary protocol diagram illustrating a protocol 300 for operating a pre-order system 350 in an online marketplace. As shown, the pre-order system 350 may create a pre-order listing 351 in response to a request 331 from a seller 330 to list a product for pre-order in the online marketplace. In some examples, the request 331 may be submitted via the seller's registered account with the retailer. After creating the pre-order listing 351, the pre-order system 350 may begin accepting bids 317 from registered buyers 310.

In some examples, the pre-order system 350 may perform bid pre-qualification 352 to disqualify bids that fail to satisfy a hidden requirement and/or restriction set by the pre-order listing 351. For example, the pre-order listing 351 may set a maximum number of bids that can be submitted by the same registered buyer. As another example, the pre-order listing 351 may set a minimum bidding price required for bids submitted by registered buyers and/or a maximum bidding price permitted to be offered by bids submitted by registered buyers. Hiding requirements and/or restrictions of the pre-order listing 351 from the pool of registered buyers may allow the pre-order system 350 to more effectively disqualify bids submitted by bot-buyers, or otherwise to more effectively identify (e.g., flag) suspected bot-buyers. More specifically, bot-buyers may generally tend to submit lots of bids for a given pre-order listing, as well as bid at extreme price points, relative to normal retail buyers. Such strategies may allow bot-buyers to secure more items for resale and/or maximize re-sell profit margins for a given situation. Because bot buyers tend to employ bidding strategies not commonly employed by traditional retail customers, the pre-order system may use hidden requirements/restrictions to target those bidding strategies in an effort to disqualify and/or identify bot buyers. It should be appreciated that, in some cases, a bid failing to satisfy a hidden requirement, or otherwise violating a hidden restriction, may not be disqualified from the pre-order listing in question, but may instead be used to identify suspected bot-buyers. For instance, a bid failing to satisfy a hidden requirement, or otherwise violating a hidden restriction, may cause the registered buyer's account to be flagged for further evaluation by the retailer. This may result in the registered buyer's account being restricted or suspended for a period of time or indefinitely, which may or may not impact the listing in question, but may otherwise prevent the registered buyer from making future purchases or submitting future bids on the online marketplace. It should also be appreciated that, in some cases, the hidden requirements and/or hidden restrictions may not necessarily disqualify a bid and/or registered buyer from consideration by the seller 330, but may nevertheless be factored into a user score assigned to the registered buyer for the listing in question.

At the end of the bidding period, the pre-order system 350 may perform pre-order processing operations 360 to settle pre-order purchases for the pre-order listing 351. The pre-order processing operations 360 may include (but are not limited to) bid prioritization, seller finalization, buyer confirmation, payment processing, and shipment processing. The pre-order system 350 may perform bid prioritization in order to generate a prioritized list of bids. The prioritized list of bids may rank bids for consideration by the seller 330 based on at least on a weighted bidding price, user scores assigned to the registered buyers, the presence or absence of downpayments accompanying submitted bids, and/or other information in the user database 357, the pre-order database 358, and/or the product database 359.

During seller finalization, pre-order system 350 sends the prioritized list of bids to the seller 330. The seller 330 may confirm that the prioritized list of bids is acceptable to use for buyer confirmation. Alternatively, the seller 330 may return a modified list of bids to use for buyer confirmation. For instance, the seller may re-rank and/or disqualify one or more of bids based on the seller's own criteria. During buyer confirmation, the pre-order system 350 will request that registered buyers who submitted successful bids confirm the pre-order purchase. Registered buyers may either confirm or withdraw their successful bid. When a registered buyer confirms a successful bid, the corresponding pre-order purchase will proceed to payment processing. When a registered buyer withdraws a successful bid, the pre-order system 350 may replace the withdrawn bid with an alternate bid from the approved list, and contact the corresponding registered buyer to request confirmation. In some examples, a buyer that withdraws a successful bid may forfeit their downpayment. Alternatively, the downpayment may be partially or fully refunded. In some examples, withdrawing a successful bid that included a downpayment may more heavily influence future user score assignments than withdrawing a successful bid that did not include a downpayment. Buyers that confirm successful bids will be prompted to provide a payment during payment processing. Once the payments have been made, the pre-order system 350 will perform shipment processing. This may include generating shipping labels to send to the seller 330 or otherwise communicating the buyer's shipping information to the seller 330 so the seller 330 can arrange shipping independently.

The pre-order system 350 includes a user database 357, a pre-order database 358, and a product database 359. The user database 357 may store information pertaining to the registered buyer's account. This may include purchase history information, IP addresses associated with the registered buyer's account (e.g., IP addresses associated with the registered buyer's devices and/or networks, etc.) user names associated with the registered buyer and/or another registered buyer having the same IP address as the registered buyer, user score elements, biological information about the registered buyer (e.g., name, age, sex, shipping address, payment information, etc.), a user account age (e.g., how long the registered buyer has had an account with the online marketplace and/or retailer), as well as registered buyer profile(s). It should be appreciated that, in some examples, IP address associations and/or other information may associated with a registered buyer's account may have recency restriction. For example, IP address(es) associated with a buyer's account may be limited to IP address(es) used by the buyer with a specified time period (e.g., six months, etc.). The registered buyer profile(s) may include an internal profile generated from the registered buyer's activity on online marketplaces and/or brick and mortar retail locations managed by the retailer as well as third party profiles the retailer purchases from third parties (e.g., profiles associated with email addresses and/or user names of the registered buyer). The pre-order database 358 may include information related to the pre-order listing, including seller information, return policies, transaction details (e.g., payment types accepted, shipping options, etc.), bidding prices and/or downpayments offered by registered buyers bidding on the pre-order listing, a quantity of items available for purchased in the pre-order listing, a process status of the pre-order listing (e.g., open for bid, bidding closed, awaiting seller finalization, awaiting buyer confirmation and/or payment, awaiting shipping confirmation), and user ID(s) associated with the seller and/or registered buyers who placed bids, a product ID(s) associated with the pre-order listing. The product database 359 may include information related to the product listed for pre-order, including product descriptions, inventory ID(s), a price range, MSRP and/or requirements/restrictions/details pertaining to the pre-order listing (hidden or otherwise), a return policy, whether the product is available for pre-order as opposed to standard purchasing, number of items available for pre-order, OEM warranty information, requirements/restrictions/details pertaining to the pre-order listing (hidden or otherwise). etc.

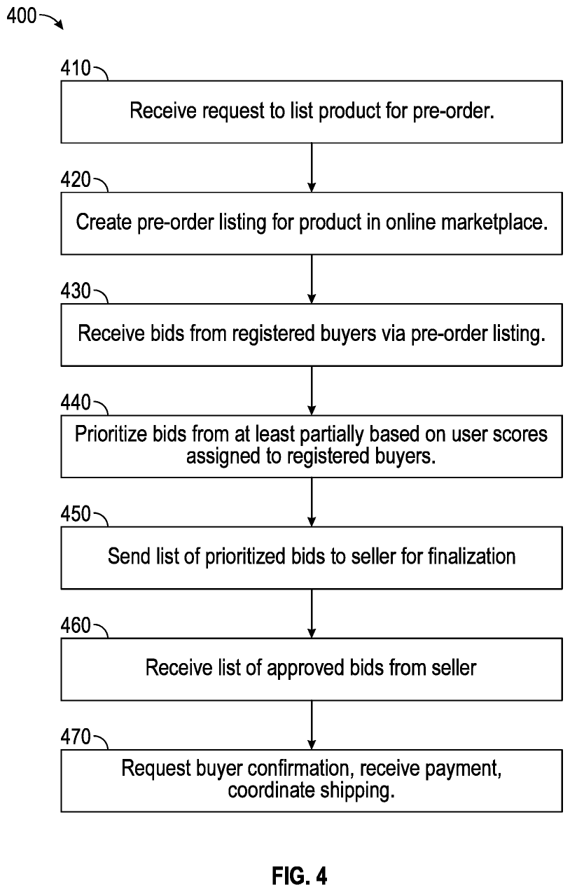

FIG. 4 is an exemplary flowchart illustrating a method 400 for operating a pre-order system. At step 410, the pre-order system receives a request to list a product for pre-order in an online marketplace. At step 420, the pre-order system creates a pre-order listing for the product in the online marketplace in response to receiving the request from the seller. At step 430, the pre-order system receives bids from registered buyers via pre-order listing. At step 440, the pre-order system prioritizes the received bids at least partially based on user scores assigned to registered buyers. The prioritized bids are then stored in a list of prioritized bids, with higher priority bids being listed ahead of lower priority bids. In some instances, the pre-order system performs bid pre-qualification prior to step 440, which may disqualify some of the bids from being included in the list of prioritized bids. At step 450, the pre-order system sends the list of prioritized bids to the seller for finalization. At step 460, the pre-order system receives an approved list of prioritized bids from seller. At step 470, the pre-order system requests buyer confirmation, receives payments from confirming buyers, and coordinates shipping.

When bot-buyers can view bidding prices offered by other buyers, they can slightly outbid traditional retail customers to secure limited availability products. Pre-order systems may use a blind bid format to deter bots and open-up opportunities for traditional retail buyers to purchase items without heavy markups. The blind bid feature may allow users to place a bid on a product without any knowledge or reference to any bids placed by other users on the same product. Aspects of this disclosure may allow sellers or retailers to restrict the number of bids placed on the website per registered buyer/user and/or per IP address. In general, normal retail customers are unlikely to bid on as many products as bot buyers, particularly within the context of the number of products listed for sale by a given retailer. Aspects of this disclosure may provide a more equal opportunity for traditional retail customers to purchase items in an online marketplace. Example pre-order systems may feature the ability to set min and max prices for pre-order listings of a given seller and/or for products offered for sale by a given seller. The min and max prices may be used instead of or in addition to MSRP, and may mutually benefit the buyer and seller. Aspects of this disclosure may allow the seller to set a reasonable min/max price. In some situations, when a buyer places a bid that exceeds the max price, the pre-order system will refund the difference. In some situations, when a buyer places a bid that's too low, the bid will be disqualified or otherwise not picked up. Aspects of this disclosure may allow buyers to provide down payments with their bids in order to allow users to increase the likelihood their bid will be successful. In some cases, buyers may offer the same price and the seller may select, or otherwise prioritize, the buyer who made the largest down payment/deposit. Aspects of this disclosure may restrict or otherwise make it more difficult for bots, and similar classes of buyers, to misuse the online marketplace. When a user places a bid, the pre-order system may record user credential, an IP address associated with the user, a bid price, and/or a downpayment amount. A user database may be used to store user credentials, IP addresses, how many times user bid on an item, how many times their bid was successful, purchase history, and/or other elements related to user score assignment. A pre-order database may store information related to the pre-order listing, including how many buyers have bid or otherwise purchased/attempted-to-purchase the product, and minimum/maximum prices for the listing. A product database may store information related to the product. One or more of the databases may individually or collectively store information related to flagged accounts (e.g., users/buyers exhibiting suspicious bidding behavior). The bidding price offered by a received bid may be weighted in relation to the user score, etc. such that the highest bidder may not necessarily win depending on the other factors impacting the user scores. The user score may be impacted by various factors. Such factors may include purchase history (e.g., how many times a user successfully purchased a product they bid on, how many times the user has purchased the same or similar product, etc.), total successful bids confirmed by the user, total successful bids withdrawn by the user, total bids submitted to pre-order system, age of user account, customer loyalty factor, how frequently user visits website, number of returns made by the user, presence or absence of a down payment, history of successful bids having downpayment that were confirmed vs withdrawn, etc. If a user is de-selected from the pre-order system, the user may be permitted to submit another bid. If a user is suspended or disqualified by the pre-order system, the user may be prevented from bidding on a specific product or from bidding on any product listed for pre-order on the online marketplace. Aspects of this disclosure may improve user experience for limited inventory purchasing, as well as reduce the load on servers processing bid/purchase requests through restricting or disqualifying bids/purchase attempts by bot-buyers. Aspects of this disclosure may limit or otherwise restrict user accounts with user scores below a threshold from bidding on specific items/products or from bidding on pre-orders in the online marketplace.

Blind bid features may allow users to place a bid on a product without any knowledge or reference to bids placed by other users on the same product.

Aspects of this disclosure may limit the number of bids a potential client can make, the number of items a potential client can bid on at once, and/or the maximum and minimum bid price allowed. Example pre-order systems may allow a potential client to place a down payment along with their bid. Some systems will allow the seller to select which bids are successful from a prioritized list or from a pool of unprioritized bids. In one example, an entity wishing to sell one-hundred of the same SKUs may wish to conduct a single auction and then choose the hundred winning bidders from a single pool. The entity may choose a specific time frame for the auction or a single day format, etc.

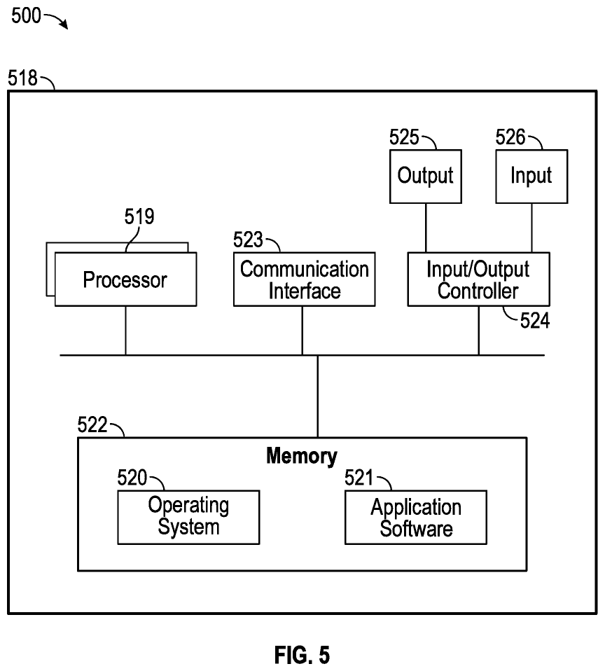

The present disclosure is operable with a computing apparatus. FIG. 5 illustrates a functional block diagram of a computing apparatus 500. In an example, components of a computing apparatus 518 are implemented as a part of an electronic device according to one or more embodiments described in this specification. The computing apparatus 518 comprises one or more processors 519 which may be microprocessors, controllers, or any other suitable type of processors for processing computer executable instructions to control the operation of the electronic device. Alternatively, or in addition, the processor 519 is any technology capable of executing logic or instructions, such as a hard-coded machine. In some examples, platform software comprising an operating system 520 or any other suitable platform software is provided on the apparatus 518 to enable application software 521 to be executed on the device. In some examples, enabling the creation of alerts and detecting anomalies using those created alerts as described herein is accomplished by software, hardware, and/or firmware.

In some examples, computer executable instructions are provided using any computer-readable media that is accessible by the computing apparatus 518. Computer-readable media include, for example, computer storage media such as a memory 522 and communications media. Computer storage media, such as a memory 522, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 522) is shown within the computing apparatus 518, it will be appreciated by a person skilled in the art, that, in some examples, the storage is distributed or located remotely and accessed via a network or other communication link (e.g., using a communication interface 523).

Further, in some examples, the computing apparatus 518 comprises an input/output controller 524 configured to output information to output device(s)525, for example a display or a speaker, which are separate from or integral to the electronic device. Additionally, or alternatively, the input/output controller 524 is configured to receive and process an input from one or more input device(s) 526, for example, a keyboard, a microphone, or a touchpad. In one example, the output device(s) 525 also acts as the input device. An example of such a device is a touch sensitive display. The input/output controller 524 may also output data to devices other than the output device, e.g., a locally connected printing device. In some examples, a user provides input to the input device(s) 526 and/or receives output from the output device 525.

The functionality described herein can be performed, at least in part, by one or more hardware logic components. According to an embodiment, the computing apparatus 518 is configured by the program code when executed by the processor 519 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method for facilitating pre-orders, the method comprising:
receiving, from a seller, a request to list a product for pre-order in an online marketplace managed by a retailer;
creating, by the retailer, a pre-order listing for the product in the online marketplace in response to receiving the request from the seller;
receiving, via the pre-order listing, a bid from a first registered buyer and a bid from a second registered buyer; and
sending, to the seller, a prioritized list of bids for the pre-order listing, wherein the bid from the second registered buyer offers a higher bidding price than the bid from the first registered buyer, and wherein the bid from the first registered buyer is prioritized over the bid from the second registered buyer at least partially based on a user score assigned to the first registered buyer being higher than a user score assigned to the second registered buyer.

2. The method of claim 1, wherein a bidding price of the bid from the first registered buyer is hidden from the second registered buyer.

3. The method of claim 1, wherein the user score assigned to the first registered buyer is at least partially based on a purchase history of the first registered buyer.

4. The method of claim 1, wherein the user score assigned to the second registered buyer is at least partially based on a number of times the product has been purchased by the second registered buyer or other registered buyers associated with the same IP address as the second registered buyer.

5. The method of claim 1, wherein the user score assigned to the second registered buyer is at least partially based on a number of times the product or a similar product has been shipped to a delivery address of the second registered buyer.

6. The method of claim 1, wherein the user score assigned to the second registered buyer is at least partially based on suspicious bidding activity associated with the second registered buyer or an IP address of the second registered buyer.

7. The method of claim 1, wherein the user score assigned to the first registered buyer is at least partially based on a number of times the first registered buyer has confirmed a successful bid following seller finalization of a previous pre-order listing on the online marketplace.

8. The method of claim 1, wherein the user score assigned to the second registered buyer is at least partially on a number of times the second registered buyer has withdrawn a successful bid following seller finalization of a previous pre-order listing on the online marketplace.

9. The method of claim 1, wherein the user score assigned to the second registered buyer is at least partially based on a number of times the second registered buyer has returned a purchased item to the retailer.

10. The method of claim 1, wherein the bid from the first registered buyer is prioritized over the bid from the second registered buyer in the prioritized list of bids at least partially due to a downpayment being included with the bid from the first registered buyer.

11. The method of claim 1, wherein the pre-order listing sets a maximum number of bids that can be submitted by the same registered buyer.

12. The method of claim 1, wherein the pre-order listing sets a minimum bidding price required for bids submitted by registered buyers, and wherein the minimum bidding price is hidden from the registered buyers.

13. The method of claim 1, wherein the pre-order listing sets a maximum bidding price permitted by bids submitted by registered buyers, and wherein the maximum bidding price is hidden from the registered buyers.

14. The method of claim 1, wherein the pre-order listing indicates how many items of the product are available for pre-order from the seller.

15. The method of claim 1, wherein the pre-order listing indicates a maximum number of items of the product that are permitted to be pre-ordered from the same registered buyer.

16. A system comprising:
a processor; and
a memory comprising computer program code, the memory and the computer program code configured to cause the processor to:
receive, from a seller, a request to list a product for pre-order in an online marketplace managed by a retailer;
create, by the retailer, a pre-order listing for the product in the online marketplace in response to receiving the request from the seller;
receive, via the pre-order listing, a bid from a first registered buyer and a bid from a second registered buyer; and
send, to the seller, a prioritized list of bids for the pre-order listing, wherein the bid from the second registered buyer offers a higher bidding price than the bid from the first registered buyer, and wherein the bid from the first registered buyer is prioritized over the bid from the second registered buyer at least partially based on a user score assigned to the first registered buyer being higher than a user score assigned to the second registered buyer.

17. A computer storage medium has computer-executable instructions that, upon execution by a processor, cause the processor to at least:
receive, from a seller, a request to list a product for pre-order in an online marketplace managed by a retailer;
create, by the retailer, a pre-order listing for the product in the online marketplace in response to receiving the request from the seller;
receive, via the pre-order listing, a bid from a first registered buyer and a bid from a second registered buyer; and
send, to the seller, a prioritized list of bids for the pre-order listing, wherein the bid from the second registered buyer offers a higher bidding price than the bid from the first registered buyer, and wherein the bid from the first registered buyer is prioritized over the bid from the second registered buyer at least partially based on a user score assigned to the first registered buyer being higher than a user score assigned to the second registered buyer.
